(19) United States
(12) Patent Application Publication
(10) Pub. No.: US 2016/0294051 A1
(43) Pub. Date: Oct. 6, 2016

(54) TRANSPONDER ANTENNA INLAY

(71) Applicant: VORBECK MATERIALS CORP., JESSUP, MD (US)

(72) Inventors: SRIRAM MANIVANNAN, BALTIMORE, MD (US); KENNETH E FRITSCH, ARNOLD, MD (US); DAN F. SCHEFFER, FREDERICK, MD (US)

(73) Assignee: VORBECK MATERIALS CORP., JESSUP, MD (US)

(21) Appl. No.: 15/090,174

(22) Filed: Apr. 4, 2016

Related U.S. Application Data
(60) Provisional application No. 62/140,229, filed on Mar. 30, 2015.

(51) Int. Cl. H01Q 1/50; H01Q 1/40; G06K 19/077; H01Q 1/22

(52) U.S. Cl. CPC H01Q 1/50; H01Q 1/2225; H01Q 1/40; G06K 19/07773

(57) ABSTRACT

Embodiments of the present invention relate to radio transponders and radio transponder antenna inlays. In an embodiment, a radio transponder comprises an integrated circuit having a memory unit. A printed antenna inlay is in electrical communication with the integrated circuit. The antenna inlay comprises a non-metallic conductive compound. The antenna inlay is non-ferromagnetic. The antenna inlay is radiolucent at wavelengths of at least 0.01 nm. The antenna inlay has a thickness of about 0.8 μm to about 150 μm.

### CROSS-REFERENCE TO RELATED APPLICATIONS

This application claims priority to U.S. Provisional Application No. 62/140,229 filed Mar. 30, 2015, which is hereby incorporated herein by reference.

### BACKGROUND

The present invention relates generally to transponders and specifically to transponder antenna inlays. Transponders are devices that typically receive and transmit electromagnetic (“EM”) signals, such as radio waves. Transponders can contain integrated circuits having memory units. Transponders receive interrogating EM signals and transmit EM signals in response thereto. Transponders typically comprise a metallic antenna. Metallic antennas have a heightened probability of being detected, which can result in their removal and/or tampering. Metallic antennas can experience corrosive events, which can impact negatively on transponder functioning.

### BRIEF DESCRIPTION OF THE DRAWINGS

FIG. 1 depicts X-ray images of a non-metallic composition, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, the term “about” denotes a range of up to ±0.1 for values of at least 1 and up to ±0.01 for values of less than 1.

Transponders are devices that typically receive and transmit electromagnetic (“EM”) signals, such as radio waves. Transponders can contain integrated circuits having memory units. Transponders receive interrogating EM signals and transmit EM signals in response thereto. Transponders typically comprise a metallic antenna. Metallic antennas have a heightened probability of being detected, which can result in their removal and/or tampering. Metallic antennas can experience corrosive events, which can impact negatively on transponder functioning. Metallic antennas are typically detectable via X-ray imaging (i.e. are non-radiolucent). Eddy currents can be induced in metallic antennas, which can result in the metallic structure producing a magnetic signature.

Embodiments of the present invention seek to provide non-metallic transponder antenna inlays. The antenna inlays of the present invention (“the antenna inlays”) are comprised of a non-metallic conductive composition (“the composition”) that is radiolucent and/or non-ferromagnetic. The composition comprises individual graphene sheets. The antenna inlays are radiolucent at wavelengths of at least about 0.01 nm. Metal detectors typically detect metallic objects by inducing eddy currents in said objects, which results in the objects producing a magnetic field. The magnetic field may subsequently be measured by a magnetometer. The non-metallic nature of the composition results in a lack of ferromagnetic characteristics. Hence, eddy currents and a resulting magnetic signature cannot be induced in the resulting antenna inlays.

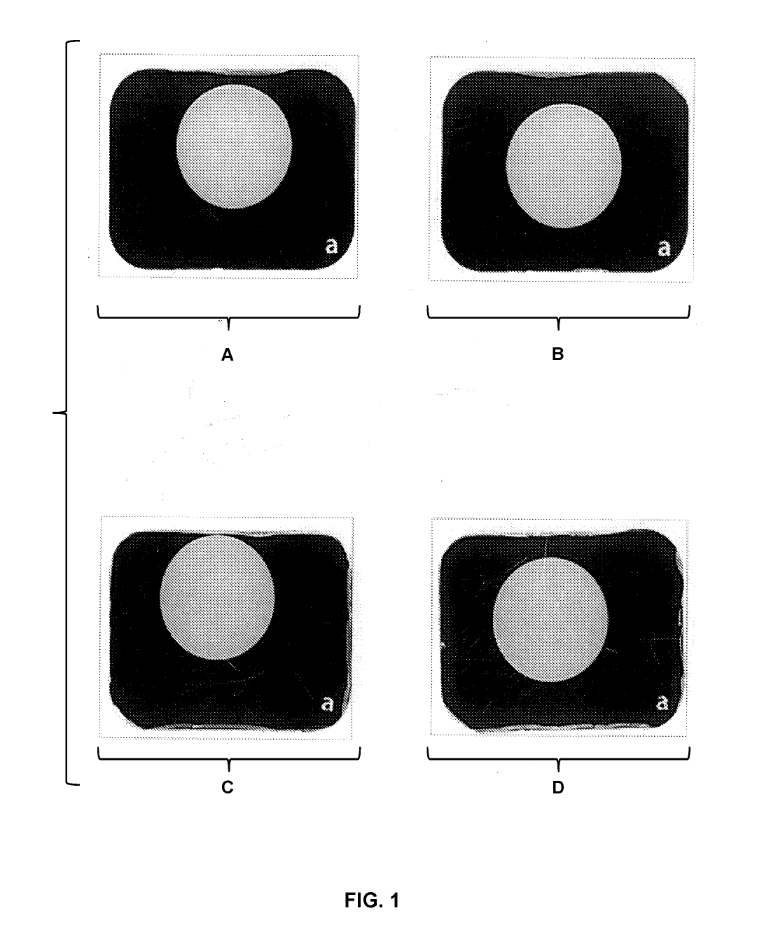

The antenna inlays can be used in a variety of transponders, for example, RFID, automotive, marine, and aviation transponders. FIG. 1 depicts several X-ray images, in accordance with an embodiment of the present invention. The images of FIG. 1 depict a sample of the composition at various thicknesses and a metal disk for comparison captured at a wavelength of 0.2 nm. Each image includes one or more layers of the composition screen printed on polyethylene terephthalate (“PET”) and a metal disk for comparison. For example, FIGS. 1A, 1B, 1C, and 1D reflect one, two, three, and four layers of the composition applied at a thickness of about 8 μm per layer, respectively. The FIGS. demonstrate that the radiolucency of the composition, depicted as black, is greater than that of the included metal disk (depicted as greyish white).

The composition can include one or more conductive materials including, but not limited to, graphene sheets, graphite, conductive carbons, and/or conductive polymers (discussed further below). The antenna inlays may be formed by applying one or more layers of the composition to the substrate surface in a pattern comprising an electrically conductive pathway designed to operate within the desired RF band. The electrically conductive pathway may be solid, mostly solid, in a liquid or gel form. Applicable RF bands include, but are not limited to, HF, VHF, UHF, L, S, C, X, Ku, K, Ka, V, W, mm, A, B, C, D E, F, G H, I, J, K, L, and M. The antenna inlays can comprise one or more interconnected non-metallic conductive antenna components, wherein at least one of the antenna components can be in communication with an IC having one or more memory units. The antenna inlays may contain multiple layers of the composition and/or substrates. Non-metallic transponder antenna inlays may comprise omnidirectional and/or omnidirectional antenna components. The antenna inlays can comprise dipole, monopole, horn, loop, Yagi-Uda, random wire, and/or patch antennas.

The antenna inlays can be linear polarized, circular polarized, monostatic and/or bistatic. In one embodiment, the antenna inlays comprise a loop antenna component that includes IC pads. The IC pads allow the antenna component to be in electronic communication with an active or passive IC (discussed below). At least two additional antenna components, such as radiating conductive elements, are in communication with and extend from opposite sides of the loop antenna element. The circumference of the loop antenna component is approximately the width of the radiating conductive elements. Radiating conductive elements can comprise multi-sided geometric shapes, including but not limited to, trapezoidal. Antenna components can radiate from the IC in a symmetrical or asymmetric manner.

The antenna inlays are designed to be utilized with an active or passive IC. The IC can operate on any carrier wave frequency. In certain embodiments, the ICs do not have any restrictions on maximum read distance, memory size, encoding scheme, and/or security protocol. The antenna inlays can comprise an electrical conductor having two or more IC pads. The IC can comprise a memory component to store data, and a processing unit to process the data and/or modulate and demodulate RF signals. The data may include, for example, identifying numbers or alphanumeric expressions, for example, a serial number, identification number, stock number, lot number, and/or batch number. The antenna inlay can receive and/or transmit RF signals.

In certain embodiments, the composition is in the form of an ink or coating (hereinafter “the ink or coating”). In certain embodiments, the composition comprises individual graphene sheets and one or more polymers. In other embodiments, the composition further comprises carbon black and/or graphite. The graphene sheets may be present relative to the total weight of the graphene sheets, graphite, and/or carbon black from about 0.2 to about 10, about 0.2 to about 8, about 0.2 to about 6, about 0.2 to about 5, about 0.2 to about 4, about 0.2 to about 3, about 0.2 to about 2.5, about 0.2 to about 2, about 0.2 to about 1, about 0.5 to about 10, about 0.5 to about 8, about 0.5 to about 6, about 0.5 to about 5, about 0.5 to about 4, about 0.5 to about 3, about 0.5 to about 2.5, about 0.5 to about 2, about 0.5 to about 1, 1 to about 10, about 1 to about 8, about 1 to about 6, about 1 to about 5, about 1 to about 4, about 1 to about 3, about 1 to about 2.5, or about 1 to about 2 weight percent.

In some embodiments, the surface resistivity of the composition may be no greater than about 10000 Ω/square/mil, 5000 Ω/square/mil, 1000 Ω/square/mil, 700 Ω/square/mil, 500 Ω/square/mil, 350 Ω/square/mil, 200 Ω/square/mil, 200 Ω/square/mil, 150 Ω/square/mil, 100 Ω/square/mil, 75 Ω/square/mil, 50 Ω/square/mil, 30 Ω/square/mil, 20 Ω/square/mil, 10 Ω/square/mil, 5 Ω/square/mil, 1 Ω/square/mil, 0.1 Ω/square/mil, 0.01 Ω/square/mil, and/or 0.001 Ω/square/mil as well as any sub-value or range of subvalues included therein. In certain embodiments, the composition has a surface resistance of about 0.1 to about 50 Ω/square/mil.

In some cases, the surface resistivity of the composition can be no greater than about 10 mega Ω/square/mil, than about 1 mega Ω/square/mil, 500 kilo Ω/square/mil, 200 kilo Ω/square/mil, 100 kilo Ω/square/mil, 50 kilo Ω/square/mil, 25 kilo Ω/square/mil, 10 kilo Ω/square/mil, 5 kilo Ω/square/mil, 1000 Ω/square/mil, 700 Ω/square/mil, 500 Ω/square/mil, 350 Ω/square/mil, 200 Ω/square/mil, 200 Ω/square/mil, 150 Ω/square/mil, 100 Ω/square/mil, 75 Ω/square/mil, or 50 Ω/square/mil, 30 Ω/square/mil, 20 Ω/square/mil, 10 Ω/square/mil, 5 Ω/square/mil, 1 Ω/square/mil, 0.1 Ω/square/mil, 0.01 Ω/square/mil, and/or 0.001 Ω/square/mil as well as any sub-value or range of values included above.

In some embodiments, the composition can have a conductivity of at least about 10⁻⁸ S/m. The composition can have a conductivity of about 10⁻⁶ S/m to about 10⁵ S/m, or of about 10⁻⁵ S/m to about 10⁵ S/m. In still other embodiments, the composition has a conductivity of at least about 0.001 S/m, 0.01 S/m, 0.1 S/m, 1 S/m, 10 S/m, 100 S/m, 1000 S/m, 10,000 S/m, 20,000 S/m, 25,000 S/m, 30,000 S/m, 40,000 S/m, 50,000 S/m, 60,000 S/m, 75,000 S/m, 10⁵ S/m, and/or at least about 10⁶ S/m as well as any sub-value or range of values included above. The composition can be formed in a manner to have at least a 70% impedence matching. The antenna inlays can be formed in a manner to have a read range of up to 7 meters.

The graphene sheets can have a surface area of about 100 m²/g to about 2630 m²/g. The graphene sheets typically have a “platey” (e.g. two-dimensional) structure that is distinct from carbon nanotubes, which are typically needle-like in structure. The two longest dimensions of the graphene sheets may each be at least about 10 times greater, about 50 times greater, about 100 times greater, about 1000 times greater, about 5000 times greater, or about 10,000 times greater than the shortest dimension (i.e. thickness) of the sheets. In some embodiments, the graphene sheets completely comprise fully exfoliated single sheets of graphite (these are approximately ≦1 nm thick and are often referred to as “graphene”), or partially exfoliated graphite sheets, wherein two or more sheets of graphite are not exfoliated from each other. The graphene sheets may comprise mixtures of fully and partially exfoliated graphite sheets. In certain embodiments, fully exfoliated individual sheets of graphene are preferred because such structures result in enhanced molecular sheet overlap, which enhances electrical conductivity. In other embodiments, the individual sheets of graphene form a three-dimensional interconnected network.

An example of a method for the preparation of graphene sheets involves the oxidation of graphite to graphite oxide, and subsequent thermal exfoliation, as described in US 2007/0092432, which is hereby incorporated by reference. The resulting graphene sheets typically display little or no signature corresponding to graphite or graphite oxide in their X-ray diffraction pattern. The thermal exfoliation may be carried out in a continuous or semi-continuous batch process.

The graphene sheets can have a surface area of at least 100 m²/g to for example, at least 200 m²/g, at least 300 m²/g, at least 350 m²/g, at least 400 m²/g, at least 500 m²/g, at least 600 m²/g, at least 700 m²/g, at least 800 m²/g, at least 900 m²/g, or at least 700 m²/g. The surface area may be 400 to 1100 m²/g. The maximum surface area can be calculated to be 2630 m²/g. The surface area can include all values and subvalues therebetween, including, for example, 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets may have a bulk density of about 0.01 to at least about 200 kg/m³. The bulk density can include all values and subvalues therebetween, including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, but not limited to, hydroxyl, carboxyl, and epoxy groups) and typically have an overall carbon to oxygen molar ratio (hereinafter “C/O ratio”), as determined by bulk elemental analysis, of at least 1:1, or at least 3:2. Examples of C/O ratio can include 3:2 to 85:15; 3:2 to 20:1; 3:2 to 30:1; 3:2 to 40:1; 3:2 to 60:1; 3:2 to 80:1; 3:2 to 100:1; 3:2 to 200:1; 3:2 to 500:1; 3:2 to 1000:1; 3:2 to greater than 1000:1; 10:1 to 30:1; 80:1 to 100:1; 20:1 to 100:1; 20:1 to 500:1; 20:1 to 1000:1; 50:1 to 300:1; 50:1 to 500:1; and 50:1 to 1000:1. In some embodiments, the C/O ratio is at least 10:1, or at least 15:1, or at least 20:1, or at least 35:1, or at least 50:1, or at least 75:1, or at least 100:1, or at least 200:1, or at least 300:1, or at least 400:1, or at least 500:1, or at least 750:1, or at least 1000:1; or at least 1500:1, or at least 2000:1. The C/O ratio also can include all values and subvalues between these ranges.

The graphene sheets may contain atomic scale kinks, which may be caused by the presence of lattice defects in, or by chemical functionalization of the two-dimensional hexagonal lattice structure of the graphite basal plane. In certain embodiments, the kinks enhance the three-dimensional interconnectivity of the individual graphene sheets.

The graphene sheets may comprise two or more graphene powders having different particle size distributions and/or morphologies. The graphite may also comprise two or more graphite powders having different particle size distributions and/or morphologies.

The compositions as used herein can refer to those that are suitable for application to a substrate as well as the material after it is applied to the substrate, while it is being applied to the substrate, and both before and after any post-application treatments, such as evaporation, crosslinking, and curing. The components of the compositions may vary during these stages. The composition may optionally further comprise a polymeric binder.

The polymers can be used as binders. Applicable polymers include, but are not limited to, thermosets, thermoplastics, and non-melt processible polymers. In an embodiment, polymers can also comprise monomers that can be polymerized before, during, or after the application of the coating to the substrate. Polymeric binders can be crosslinked or otherwise cured after the coating has been applied to the substrate. Examples of applicable polymers include, but are not limited to polyolefins (such as polyethylene, linear low density polyethylene (LLDPE), low density polyethylene (LDPE), high density polyethylene, polypropylene, and olefin copolymers), nitrile butadiene rubbers (NBR), highly saturated nitrile rubbers (HSN), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral) (PVB), poly(vinyl formal), poly(methyl methacrylate) and other acrylate polymers and copolymers (such as methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), poly(vinyl acetate) and poly(vinyl acetate) copolymers, poly(vinyl pyrrolidone) and poly(vinyl pyrrolidone) copolymers, vinyl acetate and vinyl pyrrolidone copolymers, polycarbonates (PC), polyamides, polyesters, liquid crystalline polymers (LCPs), poly(lactic acid) (PLA), poly(phenylene oxide) (PPO), PPO-polyamide alloys, polysulphone (PSU), polysulfides, polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), poly(vinyl chloride) (PVC), polyurethanes (thermoplastic and thermosetting (including crosslinked polyurethanes, such as crosslinked amines), aramides (such as Kevlar® and Nomex®), polysulfides, polytetrafluoroethylene (PTFE), polysiloxanes (including, but not limited to, polydimethylenesiloxane, dimethylsiloxane/vinylmethylsiloxane copolymers, and vinyldimethylsiloxane terminated poly(dimethylsiloxane)), elastomers, epoxy polymers (including, but not limited to, crosslinked epoxy polymers, such as those crosslinked with polysulfones and amines), polyureas, alkyds, cellulosic polymers (such as nitrocellulose, ethyl cellulose, ethyl hydroxyethyl cellulose, carboxymethyl cellulose, cellulose acetate, cellulose acetate propionates, and cellulose acetate butyrates), polyethers (such as poly(ethylene oxide), poly(propylene oxide), poly(propylene glycol), and oxide/propylene oxide copolymers), acrylic latex polymers, polyester acrylate oligomers and polymers, polyester diol diacrylate polymers, and UV-curable resins.

Examples of applicable elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Examples of applicable polyamides include, but are not limited to, aliphatic polyamides, such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-methylpentamethyleneterephthalamide. The polyamides may be polymers and copolymers (i.e., polyamides having at least two different repeat units) having melting points between 120 and 255° C. including, but not limited to, aliphatic copolyamides having a melting point of 230° C. or less, aliphatic copolyamides having a melting point of 210° C. or less, aliphatic copolyamides having a melting point of 200° C. or less, and aliphatic copolyamides having a melting point of 180° C. or less, for example Macromelt® and Versamid®.

Examples of acrylate polymers may include, but are not limited to, those made by the polymerization of one or more acrylic acids (including acrylic acid and methacrylic acid) and their derivatives, such as esters. Other examples of acrylate polymers may include methyl acrylate polymers, methyl methacrylate polymers, and methacrylate copolymers. Additional examples of acrylate polymers may include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers may comprise repeat units derived from other monomers such as olefins (e.g. ethylene and propylene), vinyl acetates, vinyl alcohols, and vinyl pyrrolidones. Still other examples of acrylate polymers may include partially neutralized acrylate polymers and copolymers (such as ionomer resins).

Examples of applicable polymers can further include Elvacite® polymers supplied by Lucite International, Inc., including Elvacite® 2009, 2010, 2013, 2014, 2016, 2028, 2042, 2045, 2046, 2550, 2552,2614, 2669, 2697, 2776, 2823, 2895, 2927, 3001, 3003, 3004, 4018, 4021, 4026, 4028, 4044, 4059, 4400, 4075, 4060, and 4102. Other polymer families include Bynel® polymers, such as Bynel® 2022 and Joncryl® polymers, such as Joncryl® 678 and 682.

The composition can comprise a ratio by weight of graphite, carbon black, and/or graphene sheets to polymer of about 2:98 to 98:2, about 5:95 to about 98:2, about 10:90 to about 98:2, about 20:80 to about 98:2, about 30:70 to about 98:2, 40:60 to about 98:2, about 50:50 to about 98:2, about 60:40 to about 98:2, about 70:30 to about 98:2, about 80:20 to about 98:2, about 90:10 to about 98:2, about 95:5 to about 98:2, 2:98 to 95:2, about 5:95 to about 95:2, about 10:90 to about 95:2, about 20:80 to about 95:2, about 30:70 to about 95:2, 40:60 to about 95:2, about 50:50 to about 95:2, about 60:40 to about 95:2, about 70:30 to about 95:2, about 80:20 to about 95:2, about 90:10 to about 95:2, about 95:5 to about 95:2, 2:98 to 90:10, about 5:95 to about 90:10, about 10:90 to about 90:10, about 20:80 to about 90:10, about 30:70 to about 90:10, 40:60 to about 90:10, about 50:50 to about 90:10, about 60:40 to about 90:10, about 70:30 to about 90:10, about 80:20 to about 90:10, about 90:10 to about 90:10, about 95:5 to about 90:10, 2:98 to 80:20, about 5:95 to about 80:20, about 10:90 to about 80:20, about 20:80 to about 80:20, about 30:70 to about 80:20, 40:60 to about 80:20, about 50:50 to about 80:20, about 60:40 to about 80:20, about 70:30 to about 80:20, about 80:20 to about 80:20, about 90:10 to about 80:20, about 95:5 to about 80:20, 2:98 to 70:30, about 5:95 to about 70:30, about 10:90 to about 70:30, about 20:80 to about 70:30, about 30:70 to about 70:30, 40:60 to about 70:30, about 50:50 to about 70:30, about 60:40 to about 70:30, about 70:30 to about 70:30, about 80:20 to about 70:30, about 90:10 to about 70:30, about 95:5 to about 70:30, 2:98 to 60:40, about 5:95 to about 60:40, about 10:90 to about 60:40, about 20:80 to about 60:40, about 30:70 to about 60:40, 40:60 to about 60:40, about 50:50 to about 60:40, about 60:40 to about 60:40, about 70:30 to about 60:40, about 80:20 to about 60:40, about 90:10 to about 60:40, about 95:5 to about 60:40, 2:98 to 50:50, about 5:95 to about 50:50, about 10:90 to about 50:50, about 20:80 to about 50:50, about 30:70 to about 50:50, 40:60 to about 50:50, about 50:50 to about 50:50, about 60:40 to about 50:50, about 70:30 to about 50:50, about 80:20 to about 50:50, about 90:10 to about 50:50, about 95:5 to about 50:50, 2:98 to 40:60, about 5:95 to about 40:60, about 10:90 to about 40:60, about 20:80 to about 40:60, about 30:70 to about 40:60, 40:60 to about 40:60, about 50:50 to about 40:60, about 60:40 to about 40:60, about 70:30 to about 40:60, about 80:20 to about 40:60, about 90:10 to about 40:60, about 95:5 to about 40:60, 2:98 to 30:70, about 5:95 to about 30:70, about 10:90 to about 30:70, about 20:80 to about 30:70, about 30:70 to about 30:70, 40:60 to about 30:70, about 50:50 to about 30:70, about 60:40 to about 30:70, about 70:30 to about 30:70, about 80:20 to about 30:70, about 90:10 to about 30:70, about 95:5 to about 30:70, 2:98 to 20:80, about 5:95 to about 20:80, about 10:90 to about 20:80, about 20:80 to about 20:80, about 30:70 to about 20:80, 40:60 to about 20:80, about 50:50 to about 20:80, about 60:40 to about 20:80, about 70:30 to about 20:80, about 80:20 to about 20:80, about 90:10 to about 20:80, about 95:5 to about 20:80, 2:98 to 10:90, about 5:95 to about 10:90, about 10:90 to about 10:90, about 20:80 to about 10:90, about 30:70 to about 10:90, 40:60 to about 10:90, about 50:50 to about 10:90, about 60:40 to about 10:90, about 70:30 to about 10:90, about 80:20 to about 10:90, about 90:10 to about 10:90, about 95:5 to about 10:90, 2:98 to 5:95, about 5:95 to about 5:95, about 10:90 to about 5:95, about 20:80 to about 5:95, about 30:70 to about 5:95, 40:60 to about 5:95, about 50:50 to about 5:95, about 60:40 to about 5:95, about 70:30 to about 5:95, about 80:20 to about 5:95, about 90:10 to about 5:95, about 95:5 to about 5:95.

Examples of applicable polyesters include, but are not limited to, poly(butylene terephthalate) (PBT), poly(ethylene terephthalate) (PET), poly(1,3-propylene terephthalate) (PPT), poly(ethylene naphthalate) (PEN), and poly(cyclohexanedimethanol terephthalate) (PCT). In some embodiments, the polymer has an acid number of at least 5, or at least 10, or at least 15, or at least 20.

In other embodiments, a binder can be present relative to graphene sheets and graphite, when used, from 1 to 99 weight percent, or from 1 to 50 weight percent, or from 1 to 30 weight percent, or from 1 to 20 weight percent, or from 5 to 80 weight percent, or from 5 to 60 weight percent, or from 5 to 30 weight percent, or from 15 to 85 weight percent, or from 15 to 60 weight percent, or from 15 to 30 weight percent, or from 25 to 80 weight percent, or from 25 to 50 weight percent, or from 40 to 90 weight percent, or from 50 to 90 weight percent, or from 70 to 95 weight percent, based on the total weight of binder and graphene plus graphite, when present. In still other embodiments, the graphene sheets are present in about 0.2 to about 10, 0.2 to about 5, or about 0.2 to about 3 weight percent relative to the total weight of graphene sheets, graphite, and carbon black

Examples of applicable solvents into which the graphene sheets and additional components can be dispersed include water, distilled or synthetic isoparaffinic hydrocarbons, such as Isopar® and Norpar® and Dowanol®, citrus terpenes and mixtures containing citrus terpenes, such as Purogen® Electron, and Positron, terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.) ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol, such as Hexasol™, dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF) and dimethylacetamide), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, and cumene), petroleum distillates, naphthas (such as VM&P naphtha), and mixtures of two or more of the foregoing and mixtures of one or more of the foregoing with other carriers. Solvents can be, for example, low- or non-VOC solvents, non-hazardous air pollution solvents, and non-halogenated solvents.

The compositions can contain additives such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, as well as conductive additives.

Examples of applicable electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, and their derivatives and copolymers. The conductive polymers may be undoped or doped, for example, with boron, phosphorous, and iodine.

Applicable conductive carbons include, but are not limited to, graphite (including natural, Kish, and synthetic, annealed, pyrolytic, highly oriented pyrolytic, and graphites), graphitized carbon, mesoporous carbon, carbon fibers and fibrils, carbon whiskers, vapor-grown carbon nanofibers, carbon nanotubes (including single- and multi-walled nanotubes), fullerenes, activated carbon, carbon fibers, expanded graphite, expandable graphite, graphite oxide, hollow carbon spheres, and carbon foams. Applicable carbon black material includes conductive carbon black material that may be of a very high purity. The carbon black material may be in a soft pellet and/or powder form. Applicable carbon black materials include, but are not limited to, Ketjen EC-600®, Emperor® 1600, 1200, and 1800, Ensaco 250G, 350G, 260G, as well as various American Society for Testing and Materials (ASTM) grade (such as N110, N115, N120, N121, N125, N134, N135, S212, N220, N231, N234, N239, N299, S315, N326, N330, N335, N339, N343, N347, N351, N356, N358, N357, N539, N550, N582, N630, N642, N650, N660, N683, N754, N762, N765, N772N774, N787, N907, N908, N990, and N991).

Inks and coatings can be formed by blending the composition with at least one solvent and/or binder, and, optionally, other additives. Such blending can be done using one or more of the preceding methods. The composition may be made using any suitable method, including wet or dry methods and batch, semi-continuous, and continuous methods, in accordance with an embodiment of the present invention. Dispersions, suspensions, solutions, etc. of graphene sheets and one or more aromatic compounds (including inks and coatings formulations) can be made or processed (e.g., milled/ground, blended, dispersed, and suspended) by using suitable mixing, dispersing, and/or compounding techniques.

For example, components of the composition, such as one or more of the graphene sheets, carbon black, graphite, binders, carriers, and/or other components can be processed (e.g., milled/ground, blended by using suitable mixing, dispersing, and/or compounding techniques and apparatus, including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills), accordance with an embodiment of the present invention. Applicable processing (including grinding) technologies can be wet or dry and can be continuous or discontinuous. Suitable materials for use as grinding media include, but are not limited to, metals, carbon steel, stainless steel, ceramics, stabilized ceramic media (such as cerium yttrium stabilized zirconium oxide), PTFE, glass, and tungsten carbide. The aforementioned methods can be used to change the particle size and/or morphology of the graphite, graphene sheets, other components, and blends or two or more components.

Components may be processed together or separately and may go through multiple processing (including mixing/blending) stages, each involving one or more components (including blends).

There are no particular limitations to the manner in which the graphene sheets, graphite, and carbon black and other components may be processed and combined. For example, graphene sheets, carbon black, and/or graphite may be processed into given particle size distributions and/or morphologies separately and then combined for further processing with or without the presence of additional components. Unprocessed graphene sheets, carbon black and/or graphite may be combined with processed graphene sheets, carbon black and/or graphite and further processed with or without the presence of additional components. Processed and/or unprocessed graphene sheets and/or processed and/or unprocessed graphite and/or processed and/or unprocessed carbon black may be combined with other components, such as one or more binders and then combined with processed and/or unprocessed graphene sheets and/or processed and/or unprocessed graphite and/or processed and/or unprocessed carbon black. Two or more combinations of processed and/or unprocessed graphene sheets and/or processed and/or unprocessed carbon black and/or processed and/or unprocessed graphite that have been combined with other components may be further combined or processed. Any of the foregoing processing steps can be done in the presence of at least one aromatic compound.

As inks and coatings, the composition can be applied to a wide variety of applicable substrates, including, but not limited to, flexible and/or stretchable materials, silicones and other elastomers and other polymeric materials, metals (such as aluminum, copper, steel, stainless steel, etc.), adhesives, heat-sealable materials (such as cellulose, biaxially oriented polypropylene (BOPP), poly(lactic acid), polyurethanes, etc.), fabrics (including cloths) and textiles (such as cotton, wool, polyesters, rayon, etc.), clothing, ceramics, silicon surfaces, wood, paper, cardboard, paperboard, cellulose-based materials, glassine, labels, silicon, laminates, corrugated materials, concrete, and brick. The substrates can be in the form of films, papers, and larger three-dimensional objects.

The substrates may have been treated with other coatings (such as paints) or similar materials before the coatings are applied. Examples include, but are not limited to, substrates (such as PET) coated with indium tin oxide, and antimony tin oxide. The substrates may be woven, nonwoven, and in mesh form. The substrates may be woven, nonwoven, and in mesh form.

The substrates may be paper-based materials, including, but are not limited to, paper, paperboard, cardboard, and glassine. The paper-based materials can be surface treated. Examples of applicable surface treatments include, but are not limited to, coatings, such as polymeric coatings, which can include PET, polyethylene, polypropylene, acetates, and nitrocellulose. Coatings may be adhesives. The paper based materials may be sized.

Examples of applicable polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid)); polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride)); polyetherimides; poly(vinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); and Mylar. The polymeric materials may be non-woven materials, such as Tyvek®. The polymeric materials may be adhesive or adhesive-backed materials, such as adhesive-backed papers or paper substitutes. The polymeric materials may be mineral-based paper substitutes, such as Teslin®. The substrate may be a transparent or translucent or optical material, such as glass, quartz, polymer (such as polycarbonate or poly(meth)acrylates (such as poly(methyl methacrylate).

The composition may be applied to the substrate using any suitable method, including, but not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is herein incorporated by reference), microprinting, pad printing, tampon printing, stencil printing, wire rod coating, drawing, flexographic printing, stamping, xerography, microcontact printing, dip pen nanolithography, laser printing, via pen or similar means, in accordance with an embodiment of the present invention. The composition, inks, and coatings can be applied in multiple layers of various thicknesses. For example, layers can have a thickness of about 0.5 μm to about 5 μm, about 5 μm to about 10 μm, about 10 μm to about 20 μm, about 20 μm to about 30 μm, about 30 μm to about 40 μm, about 40 μm to about 50 μm, about 50 μm to about 60 μm, about 60 μm to about 70 μm, about 70 μm to about 100 μm, about 100 μm to about 110 μm, about 110 μm to about 120 μm, about 120 μm to about 130 μm, about 130 μm to about 140 μm, or about 140 μm to about 150 μm. Applicable thickness ranges can include sub-values or sub-ranges of the aforementioned thickness ranges.

Subsequent to application to a substrate, the composition may be cured using any suitable technique, including, but are not limited to, drying and oven-drying (in air or another inert or reactive atmosphere), UV curing, IR curing, drying, crosslinking, thermal curing, laser curing, IR curing, microwave curing or drying, and sintering, in accordance with an embodiment of the present invention.

The composition can have a variety of thicknesses, for example, they can optionally have a thickness of at least 2 nm, or at least 5 nm. In various embodiments, the coatings can optionally have a thickness of 2 nm to 2 mm, 5 nm to 1 mm, 2 nm to 100 nm, 2 nm to 200 nm, 2 nm to 500 nm, 2 nm to 1 micrometer, 5 nm to 200 nm, 5 nm to 500 nm, 5 nm to 1 micrometer, 5 nm to 50 micrometers, 5 nm to 200 micrometers, 10 nm to 200 nm, 50 nm to 500 nm, 50 nm to 1 micrometer, 100 nm to 10 micrometers, 1 micrometer to 2 mm, 1 micrometer to 1 mm, 1 micrometer to 500 micrometers, 1 micrometer to 200 micrometers, 1 micrometer to 100 micrometers, 50 micrometers to 1 mm, 100 micrometers to 2 mm, 100 micrometers to 1 mm, 100 micrometers to 750 micrometers, 100 micrometers to 500 micrometers, 500 micrometers to 2 mm, or 500 micrometers to 1 mm.

The composition may be covered in whole or in part with additional material, such as overcoatings, varnishes, polymers, and fabrics.

What is claimed is:

1. A radio transponder comprising:
an integrated circuit having a memory unit;
a printed antenna inlay in electrical communication with the integrated circuit; and
wherein the antenna inlay comprises a non-metallic conductive compound.

2. The radio transponder of claim 1, wherein the antenna inlay is non-ferromagnetic.

3. The radio transponder of claim 1, wherein the non-metallic conductive compound comprises individual graphene sheets.

4. The radio transponder of claim 1, wherein the antenna inlay is radiolucent at wavelengths of at least 0.01 nm.

5. The radio transponder of claim 1, wherein the non-metallic conductive compound comprises a three-dimensional interconnected network of individual graphene sheets.

6. The radio transponder of claim 1, wherein the individual graphene sheets have a carbon to oxygen ratio of at least 100:1.

7. The radio transponder of claim 1, wherein the radio transponder has a read range of up to 7 meters.

8. The radio transponder of claim 1, wherein the antenna inlay has a thickness of about 0.8 μm to about 150 μm.

9. The radio transponder of claim 1, wherein the non-metallic conductive compound has at least a 70% impedance matching.

10. The radio transponder of claim 1, wherein the antenna inlay is printed on a thermoplastic material, a polyester material, a polyamide material, or a thermoplastic material.

11. A radio transponder antenna inlay comprising:
a non-metallic conductive composition printed on a substrate;
wherein the non-metallic conductive composition includes individual graphene sheets; and
wherein the non-metallic conductive composition is radiolucent and/or non-ferromagnetic.

12. The radio transponder antenna inlay of claim 11, wherein the individual sheets of graphene form a three-dimensional interconnected network.

13. The radio transponder antenna inlay of claim 11, wherein the non-metallic conductive composition is printed on a thermoplastic material, a polyester material, a polyamide material, or a thermoset material.

14. The radio transponder antenna inlay of claim 11, wherein the non-metallic conductive composition is radiolucent at wavelengths of at least 0.01 nm.

15. The radio transponder antenna inlay of claim 11, wherein the non-metallic conductive composition has a thickness of about 0.8 μm to about 150 μm.

16. The radio transponder antenna inlay of claim 11, wherein the non-metallic conductive compound has a conductivity of at least 25,000 S/m and/or at least a 70% impedance matching.

17. A method for forming a radio transponder antenna inlay comprising:
printing a non-metallic conductive composition on a substrate surface;
wherein the non-metallic conductive composition is radiolucent and/or non-ferromagnetic; and
wherein the non-metallic conductive composition includes individual graphene sheets.

18. The method for forming a radio transponder of claim 17, wherein the non-metallic conductive composition comprises is printed to a thickness of about 0.8 μm to about 150 μm.

19. The method for forming a radio transponder of claim 17, wherein the non-metallic conductive compound has at least a 70% impedance matching.

20. The method for forming a radio transponder of claim 17, wherein the non-metallic conductive compound has a conductivity of at least 25,000 S/m.
